(19) United States
(12) Patent Application Publication
(10) Pub. No.: US 2016/0303833 A1
(43) Pub. Date: Oct. 20, 2016

(54) Non-PVC Label Film for Printing

(71) Applicant: Avery Dennison Corporation, Glendale, CA (US)

(72) Inventors: Shanshan WANG, Mentor, OH (US); Melissa ARNETT, Concord, OH (US); David G. BLAND, Concord, OH (US); Wen-Li A. CHEN, Rochester, NY (US); Ben XU, Mentor, OH (US)

(21) Appl. No.: 15/098,367

(22) Filed: Apr. 14, 2016

Related U.S. Application Data
(60) Provisional application No. 62/147,691, filed on Apr. 15, 2015.
(60) Provisional application No. 62/300,165, filed on Feb. 26, 2016.

(51) Int. Cl. B32B 27/08; C08L 23/06; G09F 3/10; C08L 23/08; G09F 3/02; C08L 23/12; B32B 27/32

(52) U.S. Cl. CPC B32B 27/08; C08L 23/12; C08L 23/06; B32B 27/32; C08L 23/0853; G09F 3/02; G09F 3/10; B32B 2250/246; B32B 2519/00; G09F 2003/0257; B29C 47/0021

(57) ABSTRACT

Various polymeric compositions are described which are particularly well suited for use in forming films for printing. The films can be incorporated in label assemblies and can be subjected to high temperature printing operations without exhibiting excessive curling or other undesirable properties.

### CROSS-REFERENCE TO RELATED APPLICATIONS

The present application claims the benefit of U.S. Provisional Patent Application No. 62/147,691 filed Apr. 15, 2015 and 62/300,165 filed Feb. 26, 2016, both of which are incorporated herein by reference in their entireties.

### FIELD

The present subject matter relates to films free of polyvinyl chloride (PVC) and which have characteristics enabling the films to be used in labels which can be printed using laser printing technology.

### BACKGROUND

Solid toner laser printing technology or more commonly known as “laser printing” is widely used in digital printing of pressure sensitive adhesive labels. Typically, laser printing is used in applications which require on-demand printing, short turnaround time, and image modification between each impression. Laser printers use electrostatic xerographic digital printing. A critical step in the printing process to ensure ink anchorage on print media is the fusing process. In a typical fusing process, print media having powdered ink particles, i.e., toner, on its surface passes through a heated roller, i.e., a fuser roll and a pressure backing roller. Intense heat and pressure are applied to melt and fuse the toner into the print media. The high heat in the fusing process presents challenges for the use of thermally sensitive plastic labels.

A typical plastic pressure sensitive label comprises a plastic film providing a print side, a pressure sensitive adhesive on a back side which is opposite the print side, and a release liner on the back side. The high heat from the fuser roll can distort or melt low heat resistance film and also cause jamming or other disruption of the printing process. In extreme cases, if the print media becomes jammed or lodged in the printer, the long dwelling time in the printer can potentially melt the plastic film and leave pieces of film in the printer which then necessitates removal of the pieces and/or cleaning.

Another issue in laser printing relates to non-symmetric heating occurring on both sides of the print media which can result in “curling” of the print media after printing. The fuser roll which contacts the print side of media can have a temperature as high as 365° F. (185° C.) depending on the printing conditions. Other rolls such as a rubber back roll which contacts the non-print side of the media are typically not heated, thus promoting a temperature difference between opposite sides of the print media.

After exposure to relatively high temperatures and upon cooling, many plastic films will shrink or dimensionally contract. This is due to polymer chains in the films not having been fully relaxed in the film making process. The degree of shrinkage and level of the resulting shrink tension is related to the exposed temperature and the chemistry of the film as well as the process history of the film. Significant temperature differences between the print side and the back side of print media can cause shrinkage differences between the two sides, and as a result the print media typically curls after print. Laser printer post print curls are a very common issue for pressure sensitive adhesive labels, especially for labels with paper liners. In some cases, the label sheets will “tube up” similar to a scroll after printing. Any post print curl is undesirable and in some instances detrimentally affects the aesthetics of the print and can cause problems in sheet stacking and other downstream operations, as well as end application. Thus, post print “layflat” characteristics are highly desirable.

In current markets, a plastic label face film is typically considered more attractive than a paper face due to various reasons including greater water resistance, greater tear resistance, improved aesthetics, etc. Although vinyl has been used as a low cost plastic label face for many years, the use of vinyl creates a number of environmental concerns.

Accordingly, a need exists for economical films that are PVC-free and which can be used in pressure sensitive adhesive labels having paper release liners with good heat resistance; which exhibit good laser printer post print layflat characteristics for printing processes; good die cutability, perforation, and sheeting for label converting processes; and good flexibility and conformability properties which are required for labeling non-flat surfaces or substrates.

### SUMMARY

The difficulties and drawbacks associated with previous approaches are addressed in the present subject matter as follows.

In one aspect, the present subject matter provides a single layer film comprising a blend of at least one polyolefin having a Tg less than 20° C., and at least one polymer having a Tg of at least 80° C. The weight proportion of the at least one polymer having a Tg of at least 80° C. is at least 10% based upon the total weight of the film. The film is also free of polyvinyl chloride. And, the film exhibits a shrinkage of less than 1% after exposure to a temperature of 100° C. for a time period of 1 hour.

In another aspect, the present subject matter provides a multilayer film comprising a first layer including at least one polyolefin having a Tg less than 20° C., and a second layer including at least one polymer having a Tg of at least 80° C. The weight proportion of the at least one polymer having a Tg of at least 80° C. is at least 10% based upon the total weight of the film, and the film is free of polyvinyl chloride.

In another aspect, the present subject matter provides a coated film comprising a single layer film including a blend of (i) at least one polyolefin having a Tg less than 20° C., and (ii) at least one polymer having a Tg of at least 80° C. The weight proportion of the at least one polymer having a Tg of at least 80° C. is at least 10% based upon the total weight of the film. And the film is free of polyvinyl chloride. The coated film also comprises the single layer film defining an outer surface and a coating disposed on the outer surface of the single layer film.

In another aspect, the present subject matter provides a coated film comprising a multilayer film including (i) a first layer including at least one polyolefin having a Tg less than 20° C., and (ii) a second layer including at least one polymer having a Tg of at least 80° C. The weight proportion of the at least one polymer having a Tg of at least 80° C. is at least 10% based upon the total weight of the film, and the film is free of polyvinyl chloride. The coated film also comprises the multilayer film defining an outer surface and a coating disposed on the outer surface of the multilayer film.

In yet another aspect, the present subject matter provides a label laminate comprising a single layer film including a blend of (i) at least one polyolefin having a Tg less than 20° C., and (ii) at least one polymer having a Tg of at least 80° C., wherein the weight proportion of the at least one polymer having a Tg of at least 80° C. is at least 10% based upon the total weight of the film, and the film is free of polyvinyl chloride. The label laminate also comprises pressure sensitive adhesive disposed on the single layer film. And, the label laminate additionally comprises a release liner disposed on the pressure sensitive adhesive.

In still another aspect, the present subject matter also comprises a label laminate comprising a multilayer film including (i) a first layer including at least one polyolefin having a Tg less than 20° C., and (ii) a second layer including at least one polymer having a Tg of at least 80° C., wherein the weight proportion of the at least one polymer having a Tg of at least 80° C. is at least 10% based upon the total weight of the film, and the film is free of polyvinyl chloride. The label laminate also comprises pressure sensitive adhesive disposed on the multilayer film. And, the label laminate additionally comprises a release liner disposed on the pressure sensitive adhesive.

In an additional aspect, the present subject matter provides a single layer film adapted for use as laser print media. The film comprises a blend of at least one polyolefin having a Tg less than 20° C., and at least one polymer having a Tg of at least 80° C. The weight proportion of the at least one polymer having a Tg of at least 80° C. is at least 10% based upon the total weight of the film, and the film is free of polyvinyl chloride.

In yet an additional aspect, the present subject matter provides a method for forming a single layer film comprising forming a melt blend of (i) at least one polyolefin having a Tg less than 20° C., and (ii) at least one polymer having a Tg of at least 80° C. The weight proportion of the at least one polymer having a Tg of at least 80° C. is at least 10% based upon the total weight of the film, and the melt blend is free of polyvinyl chloride. The method also comprises extruding the melt blend into a layer to thereby form the single layer film, whereby the film exhibits a shrinkage of less than 1% after exposure to 100° C. for 1 hour.

In still a further aspect, the present subject matter provides a method for forming a multilayer film. The method comprises forming a first melt blend including at least one polyolefin having a Tg less than 20° C. The method also comprises forming a second melt blend including at least one polymer having a Tg of at least 80° C. The method additionally comprises coextruding the first melt blend and the second melt blend to thereby form the multilayer film. The weight proportion of the at least one polymer having a Tg of at least 80° C. is at least 10% based upon the total weight of the film, and the film is free of polyvinyl chloride.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is a schematic cross sectional illustration of a label laminate in accordance with the present subject matter.

FIG. 2 is a schematic cross sectional illustration of a single layer label face film in accordance with the present subject matter.

FIG. 3 is a schematic cross sectional illustration of a multilayer label face film in accordance with the present subject matter.

FIG. 4 is a schematic cross sectional illustration of another multilayer label face film in accordance with the present subject matter.

FIG. 5 is a schematic cross sectional illustration of another multilayer label face film in accordance with the present subject matter.

FIG. 6 is a schematic cross sectional illustration of a coated film in accordance with the present subject matter.

FIG. 7 is a schematic cross sectional illustration of another coated film in accordance with the present subject matter.

### DETAILED DESCRIPTION OF THE EMBODIMENTS

The present subject matter provides non-PVC films or rather, films that are free of PVC or “PVC-free”, and pressure sensitive adhesive label laminates using such films that exhibit good heat resistance during laser printer printing and good layflat characteristics after printing. In many embodiments of the present subject matter, the films are dimensionally stable and exhibit no or low amounts of shrinkage upon exposure to heating. In particular embodiments, films of the present subject matter exhibit a shrinkage or dimensional change of less than 1.0% after exposure to a temperature of 100° C. for a time period of 1 hour. The present subject matter also provides various coated films utilizing the noted films.

The pressure sensitive label laminates of the present subject matter have been found to exhibit good heat resistance; good laser printer post print layflat characteristics for printing processes; good die cutability, perforation, and sheeting for label converting processes; and good flexibility and conformability properties which are required for labeling non-flat surfaces or substrates.

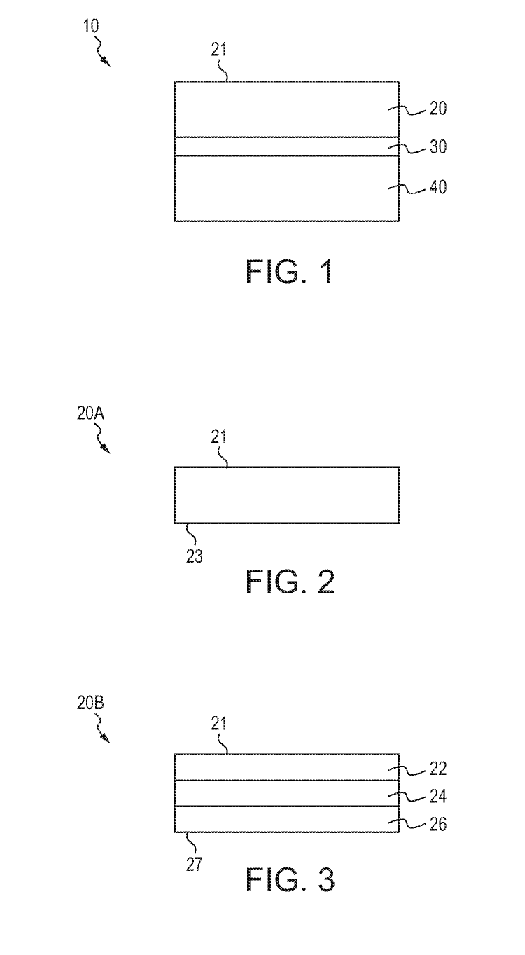

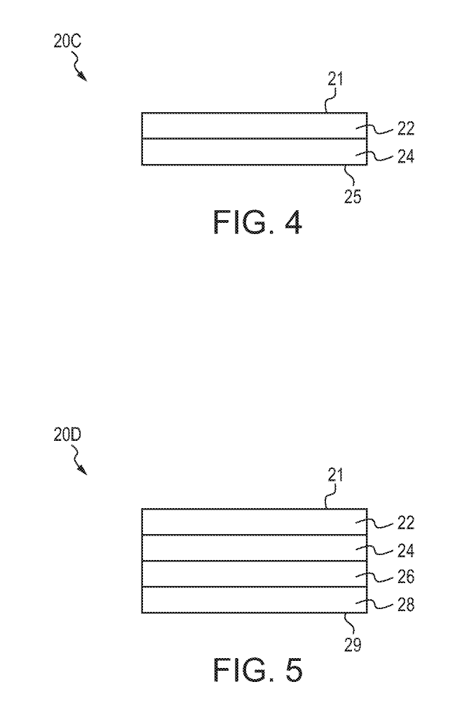

The label laminates generally comprise a film layer, a layer or region of a pressure sensitive adhesive, and a release liner as illustrated in FIG. 1. The film layer may include or constitute a coated film, such as described herein. Specifically, FIG. 1 illustrates a label laminate 10 comprising one or more film layer(s) collectively referenced as 20, pressure sensitive adhesive 30, and a release liner 40. The film layer(s) 20 define an outer surface 21 for receiving print and/or coatings as described herein. The pressure sensitive adhesive 30 is typically in the form of a layer and disposed between the film layer(s) 20 and the release liner 40. The film 20 is periodically referred to herein as “a label face film” and is a single layer or multilayer collection of films, as shown in FIGS. 2 and 3-5, respectively. Specifically, FIG. 2 illustrates a single layer film 20A, FIG. 3 illustrates a multilayer film 20B, FIG. 4 illustrates a multilayer film 20C, and FIG. 5 illustrates a multilayer film 20D. The single layer film 20A defines the outer surface 21 and an oppositely directed inner surface 23. The multilayer film 20B includes first, second, and third film layers 22, 24, and 26, respectively. The film 20B defines the outer surface 21 and an oppositely directed inner surface 27. The multilayer film 20C includes first and second film layers 22 and 24 respectively. The film 20C defines the outer surface 21 and an oppositely directed inner surface 25. The film 20D includes first, second, third, and fourth layers 22, 24, 26, and 28, respectively. The film 20D defines the outer surface 21 and an oppositely directed inner surface 29.

The single layer face film, i.e., film 20A in FIG. 2, comprises a blend of (i) one or more polyolefin(s) with a glass transition temperature (Tg) below ambient temperature and (ii) one or more polymer(s) with Tg of at least 80° C. or greater. The term “ambient temperature” as used herein refers to a temperature of 20° C.

The multilayer face film 20B in FIG. 3 comprises at least three layers with at least one layer comprised of one or more polymer(s) with a Tg of at least 80° C. or greater, and at least one layer comprised of one or more polyolefin(s) with a Tg below ambient temperature.

The multilayer face film 20C in FIG. 4 comprises at least two layers with at least one layer comprised of one or more polymer(s) with a Tg of at least 80° C. or greater, and at least one layer comprised of one or more polyolefin(s) with a Tg below ambient temperature.

The multilayer face film 20D of FIG. 5 comprises at least four layers with at least one layer comprised of one or more polymer(s) with a Tg of at least 80° C. or greater, and at least one layer comprised of one or more polyolefin(s) with a Tg below ambient temperature.

The multilayer face films 20B, 20C, and 20D depicted in FIGS. 3-5 may take a variety of different configurations and arrangements. For example, in certain embodiments, the layer 22 of the films 20B, 20C, and 20D may include at least one polyolefin having a Tg less than 20° C., and/or may include at least one polyolefin having a Tg of at least 80° C. In certain embodiments, the layer 24 of the films 20B, 20C, and 20D may include at least one polyolefin having a Tg less than 20° C., and/or may include at least one polyolefin having a Tg of at least 80° C. In certain embodiments, the layer 26 of the films 20B and 20D may include at least one polyolefin having a Tg less than 20° C., and/or may include at least one polyolefin having a Tg of at least 80° C. In certain embodiments, the layer 28 of the film 20D may include at least one polyolefin having a Tg less than 20° C., and/or may include at least one polyolefin having a Tg of at least 80° C.

In both the single layer and multilayer embodiments, the weight proportion of the polymer with a Tg of at least 80° C. or greater is at least 10% based upon the total weight of the film.

In both the single layer and multilayer embodiments, one or more high heat resistant polymers having a Tg of at least 80° C. may be used for the polymer(s) having a Tg of 80° C. or greater. The term “high heat resistant” refers to characteristic(s) of the polymer whereby upon exposure to temperatures of 100° C., more particularly of 150° C., and in particular versions, of 200° C.; the polymer does not undergo significant shrinkage. That is, upon forming a film consisting exclusively of the high heat resistant polymer(s) having a Tg of at least 80° C., and exposing the film to the noted temperature of at least 100° C., resulting shrinkage of the film after cooling to ambient temperature is less than 1.0%, more particularly less than 0.5%, and in certain embodiments less than 0.1%. Shrinkage, if any, is calculated by comparing the surface area of a face of the film before and after the noted heating. The conditions for film exposure correspond to exposure conditions typical for a laser printing operation.

In particular embodiments such as the multilayer film 20B shown in FIG. 3, the composition of the layer 24 can be the same or different than the composition of the layer 22 and/or layer 26. Similarly, in particular embodiments such as the multilayer film 20D shown in FIG. 5, the composition of the layer 24 can be the same or different than the composition of any one or more of layers 22, 26, and 28. And, the composition of the layer 26 can be the same or different than the composition of any one or more of layers 22, 24, and 28.

Polyolefins with a Tg below ambient temperature exhibit certain film comformability characteristics that are suitable for label applications. Nonlimiting examples of polyolefin(s) with a Tg below ambient temperature include polyethylene, polypropylene, polyethylene polypropylene copolymer, polyolefin elastomer, modified polyolefin, etc. Combinations of one or more of these polyolefins can be used. However, it will be appreciated that the present subject matter is not limited to any of these, and instead includes other polymers having the noted glass transition temperature(s). Additional examples of such polymers which can potentially be used are described herein.

Nonlimiting examples of polymer(s) with a Tg of 80° C. or greater include polystyrene, impact modified polystyrene, polystyrene based copolymer, cyclic polyolefin copolymer(s) and particularly those with a high norbornene content, nylon, polycarbonate, polyester, poly(meth) acrylate, polyimide, etc. Combinations of one or more of these polymers can be used. However, it will be appreciated that the present subject matter is not limited to any of these, and instead includes other polymers having the noted glass transition temperature(s). Additional examples of such polymers which can potentially be used are described herein.

The single layer and multilayer films of the present subject matter are free of polyvinyl chloride (PVC). As will be appreciated, such PVC-free films can be more readily recycled and/or are more environmentally friendly as compared to polymer films containing PVC. Although the present subject matter is directed to PVC-free films in which the films do not contain any PVC, it is contemplated that the present subject matter also includes films which exhibit the noted heat resistance and layflat characteristics described herein, yet which may also include trace amounts of PVC which may for example be as high as about 0.1% by weight.

The present subject matter also relates to the previously noted single and multilayer films used as a label face film which is well suited for laser printing. More particularly, the present subject matter relates to the noted PVC-free films and their use in label laminates.

The label face film may be glossy or matte and provide suitable scratch resistance, opacity, conformability, tensile properties, and pressure sensitive label converting properties such as for example mechanical die cutability, matrix stripping, perforation, sheeting, etc. Moreover, as described in greater detail herein, the label face films exhibit good heat resistance, pass a jamming melt test, and exhibit post print layflat characteristics in laminate form after laser printing.

In many embodiments, the label film is a single or multilayer extruded film and the film may optionally include one or more top coating(s) for other functionality. The pressure sensitive adhesive label laminates comprise (i) the previously noted label film, (ii) pressure sensitive adhesive layer along a non-print side of the label, and (iii) a release liner on the other side of the adhesive layer.

In one embodiment, the label film is single layer comprising a blend of (i) one or more polyolefin(s) with a Tg below ambient temperature, and (ii) one or more polymer(s) with a Tg of at least 80° C. or greater. The weight proportion of the polymer(s) with a Tg of 80° C. or greater is at least 10% based upon the total weight of the film.

In another embodiment, the label film is a multilayer film comprising at least two layers with at least one layer comprised of polymer with a Tg of at least 80° C. or greater, and at least one layer comprised of one or more polyolefin(s) with Tg below ambient temperature. The weight proportion of the polymer(s) with a Tg of 80° C. or greater is at least 10% based upon the total weight of the film.

In another embodiment, the label laminate comprises a single or multilayer label film as described herein, a pressure sensitive adhesive layer, and a paper release liner.

In another embodiment, the label laminate comprises one or more coating layer(s) on the surface of the label face film.

Additional details and aspects of the various films and label laminates incorporating such films, methods for forming such, and representative uses and applications are as follows.

### Films

As noted, the single and multilayer films of the present subject matter are free of PVC and comprise (i) at least one polyolefin having a Tg less than 20° C., and (ii) at least one polymer having a Tg of at least 80° C.

A representative, but non-exclusive, list of polyolefins suitable for use includes polyethylene, polypropylene, polybutene (e.g., poly 1-butene), ethylene copolymers (such as linear low density polyethylene and other copolymers of ethylene and another monomer or monomers, e.g., hexene, butene, octene, etc.), propylene copolymers, butylene copolymers, and compatible blends thereof. For the purposes of this disclosure, two polymeric materials are considered to be “compatible” if they are capable of existing in close and permanent physical association without exhibiting gross symptoms of polymer segregation. A polymer blend that is heterogenous on a macroscopic level is considered to be incompatible.

The polyethylene can comprise a very low density polyethylene (VLDPE), a low density polyethylene (LDPE), a linear low density polyethylene (LLDPE), a medium density polyethylene (MDPE), or a mixture of any of the foregoing polyethylenes. The mixture of polyethylenes can comprise two or more polyethylenes of the same type such as for example a mixture of two linear low density polyethylenes or can comprise two or more polyethylenes taken from two or more different types such as for example a mixture of a LLDPE and a MDPE.

The polypropylene can comprise a polypropylene homopolymer, a polypropylene copolymer, or a mixture of any of the foregoing polymers.

In another embodiment, the polypropylene may be a propylene copolymer, and the propylene copolymers comprise polymers of propylene and up to about 40% by weight of at least one alpha-olefin selected from ethylene and alpha-olefins containing from 4 to about 12, or from 4 to about 8 carbon atoms. Examples of useful alpha-olefins include ethylene, 1-butene, 1-pentene, 4-methyl-1-pentene, 1-hexene, 1-heptene, and 1-octene. In one embodiment, the polymers of propylene which are utilized in the present subject matter comprise polymers of propylene with ethylene, 1-butene, 1-hexene or 1-octene. The propylene alpha-olefin polymers useful in the present subject matter include random as well as block copolymers although the random copolymers generally are particularly useful. In one embodiment, the films are free of impact copolymers. Blends of two or more propylene copolymers as well as blends of the propylene copolymers with propylene homopolymers can be utilized.

In one embodiment, the propylene copolymers are propylene-ethylene copolymers with ethylenic contents from about 0.2% to about 10% by weight. In another embodiment, the ethylene content is from about 3% to about 10% by weight, or from about 3% to about 6% by weight. With regard to the propylene-1-butene copolymers, 1-butene contents of up to about 15% by weight are useful. In one embodiment, the 1-butene content generally may range from about 3% by weight up to about 15% by weight, and in other embodiments, the range may be from about 5% to about 15% by weight. Propylene-1-hexene copolymers may contain up to about 35% by weight 1-hexene. In one embodiment, the amount of 1-hexene is up to about 25% by weight. Propylene-1-octene copolymers useful in the present subject matter may contain up to about 40% by weight of 1-octene. More often, the propylene-1-octene copolymers will contain up to about 20% by weight of 1-octene.

The film can further comprise one or more additional thermoplastic polymers. The one or more additional thermoplastic polymers can comprise polyolefins other than polyethylenes and polypropylenes, alkene-unsaturated carboxylic acid or unsaturated carboxylic acid derivative copolymers, styrene-based polymers or copolymers, polyurethanes, polycarbonates, polyamides, fluoroplastics, poly(meth)acrylates, polyacrylonitriles, polyesters, or a mixture of any of the foregoing polymers.

Cyclic olefin copolymers are also known as cyclo ethylene copolymer, COC, cyclo olefin copolymer, cyclic olefin polymer, and ethylene-norbornene copolymer. The terms “cyclic olefin copolymer” or “COC” are used interchangeably herein and include these various terms of art. It is contemplated that in certain embodiments, various norbornene-based materials may be used instead of or in addition to the COC's, as described in greater detail herein. And, in particular embodiments, an elastomeric COC is used. In certain embodiments, the COC is a semi-crystalline COC. And, in other embodiments, the COC is an amorphous COC. In other embodiments, it is preferred to utilize blends of one or more of these COCs and optionally with other materials such as polyolefins, tie components, and/or amorphous COCs as described in greater detail herein.

Presently, there exist numerous grades of commercially available cyclic olefin copolymers based on different types of cyclic monomers and polymerization methods. Cyclic olefin copolymers are typically produced by chain copolymerization of cyclic monomers such as 8,9,10-trinorborn-2-ene (norbornene) or 1,2,3,4,4a,5,8,8a-octahydro-1,4:5,8-dimethanonaphthalene (tetracyclododecene) with ethene. Non-limiting examples of commercially available cyclic olefin copolymers include those available from TOPAS Advanced Polymers under the designation TOPAS, Mitsui Chemical's APEL, or those formed by ring-opening metathesis polymerization of various cyclic monomers followed by hydrogenation, which are available from Japan Synthetic Rubber under the designation ARTON, and Zeon Chemical's ZEONEX and ZEONOR.

The film can further comprise one or more additives as described in U.S. Pat. No. 6,821,592. The one or more additives can comprise an antiblock agent, a processing aid, a slip agent, an antistatic agent, a pigment, a cavitating agent, an inorganic filler, an antioxidant, or a mixture of any of the foregoing additives.

The antiblock agent can comprise a concentrate of about 3 to 80% by weight of an inorganic mineral or organic compound in a thermoplastic polymer matrix such as for example 5% by weight of an amorphous silica in a polyolefin matrix. In another example, the antiblocking agent may comprise from about 2% to 10% of an acrylate polymer in a polyolefin. An example of such an antiblocking agent is AMPACET 401960 which comprises about 5% by weight of polymethylmethacrylate (PMMA) in propylene homopolymer. In one embodiment the skin layer may contain from about 1 to about 10% of an antiblocking agent. In another embodiment, the antiblock agent can be present in one or more layers of the polymeric film of the present subject matter at a range of about 100 to 10,000 or 200 to 5,000 or 300 to 1,000 ppm by weight based on the weight of the layer. Antiblock agents as well as slip agents, processing aids and antistatic agents provide improvement in performance to a film and derivative label due to surface properties. Consequently when present in the film, these additives are generally present in one or both of the outermost layers.

The pigment can comprise an inorganic pigment comprising titanium dioxide, calcium carbonate, talc, an iron oxide, a carbon black, or a mixture of any of the foregoing inorganic pigments; an organic pigment; or a mixture of any of the foregoing pigments. The pigment can comprise a concentrate of about 20 to 80% by weight of an inorganic pigment and/or organic pigment in a thermoplastic matrix. The pigment concentrate can be present in one or more layers of the polymeric film of the present subject matter at a range of about 0.5 to 20% by weight based on the weight of the layer to provide color to and/or opacify the film. An opaque film will generally have an opacity of at least 70%, at least 75%, or at least 80%. The pigment concentrate is generally in an interior layer when present in the film.

As previously noted, the label face film can be a single layer film or a multilayer film. The multilayer film can include nearly any number of layers such as from 2 to about 8 however, in many embodiments the multilayer film includes 2 layers, 3 layers, 4 layers, or 5 layers.

In some embodiments, the multilayer film comprises a tie layer to enhance the adhesion between different adjacent layers.

As previously noted, in many embodiments of the present subject matter the film(s) exhibit no or low amounts of shrinkage upon exposure to heating, i.e., 100° C. for 1 hour. In certain embodiments, upon exposure to 100° C. for 1 hour, film(s) of the present subject matter exhibit a shrinkage of less than 1.0%. Without being limited to any particular theory, it is believed that the low extents of shrinkage of film(s) of the present subject matter promote the desirable layflat characteristics of laser print media, label laminates, or sheets utilizing the film(s). This in turn also enables thinner liners or support sheets to be used in label laminates utilizing the present subject matter films.

Low film shrinkage can be controlled by combining (i) selection(s) of the film chemical composition and (ii) fully relaxing polymer chains in the film during a film extrusion process. Thus, as described herein, in many embodiments, the single layer or multilayer films are produced using a film extrusion process.

In certain embodiments, it has also been discovered that when utilizing multilayer structures of films, e.g., multiple layers of the films, good layflat characteristics are also promoted by particular arrangements of the layers. In particular embodiments, it has been found that for a multilayer film to be exposed to relatively high temperatures on only one face, such as may occur during laser printing, good layflat characteristics result when the polymer(s) having a Tg of at least 80° C. are located in layer(s) farthest from the high temperatures (fuser roll side) and when the layer(s) close to the high temperatures (fuser roll side) are free of polymers having a Tg of at least 80° C.

The various single layer and multilayer films of the present subject matter can be produced using a variety of techniques and processes. In many embodiments of the present subject matter, the films are produced using one or more extrusion processes. In the extrusion of plastics, a raw compound material is typically in the form of small beads of resin that are gravity fed from a top mounted hopper into the barrel of an extruder. Additives such as colorants and UV inhibitors (in either liquid or pellet form) are often used and can be mixed into the resin prior to arriving at the hopper.

Sheet/film extrusion is used to extrude plastic sheets or films. Generally, two types of dies are used: a T-shaped die and a “coat hanger” die. The purpose of these dies is to reorient and guide the flow of polymer melt from a single round output from the extruder to a thin, flat planar flow. Both die types ensure constant and uniform flow across the entire cross sectional area of the die. Cooling is typically achieved by passing or pulling the extruded sheet or film through a set of cooling rolls (calendar or “chill” rolls). In sheet extrusion, these rolls not only deliver the necessary cooling but also determine sheet thickness and surface texture. Often coextrusion is used to apply one or more layers on a base material to obtain specific properties such as UV-absorption, texture, oxygen permeation resistance, or energy reflection.

Coextrusion also includes the extrusion of multiple layers of material simultaneously. This type of extrusion utilizes two or more extruders to melt and deliver a steady volumetric throughput of different viscous plastics to a single extrusion head or die which will extrude the materials in the desired form. The layer thicknesses are controlled by the relative speeds and sizes of the individual extruders delivering the materials. Extrusion coating can also be used to coat an additional layer onto an existing rollstock of paper, foil, or film.

In a particular embodiment, a process for forming a single layer film as described herein is provided. The process comprises forming a melt blend of (i) at least one polyolefin having a Tg less than 20° C., and (ii) at least one polymer having a Tg of at least 80° C., wherein the weight proportion of the at least one polymer having a Tg of at least 80° C. is at least 10% based upon the total weight of the film. In many versions, the melt blend is free of polyvinyl chloride. The process also comprises extruding the melt blend into a layer to thereby form the single layer film as described herein. The film exhibits a shrinkage of less than 1% after exposure to 100° C. for 1 hour.

In another particular embodiment, a process for forming a multilayer film as described herein is provided. The process comprises forming a first melt blend including at least one polyolefin having a Tg less than 20° C. The process also comprises forming a second melt blend including at least one polymer having a Tg of at least 80° C. And, the process also comprises coextruding the first melt blend and the second melt blend to thereby form the multilayer film. The coextrusion is performed such that the weight proportion of the at least one polymer having a Tg of at least 80° C. is at least 10% based upon the total weight of the film. In many versions, the resulting multilayer film is free of polyvinyl chloride.

The present subject matter also provides films produced by these extrusion processes. Specifically, a single layer film is provided formed by the noted extrusion process. And, a multilayer film is provided formed by the noted coextrusion process. As noted, in many embodiments the various single layer and multilayer films of the present subject matter are made by film extrusion process(es).

### Coated Films

The coated films of the present subject matter include a single layer film as described herein having one or more coatings disposed on an outer face of the film. The coated film can alternatively include a multilayer film as described herein having one or more coatings disposed on an outer face of the film. As described in greater detail herein, the one or more coatings can include ink receptive coating(s), heat insulating coating(s), and/or foam or foamed coatings. In certain embodiments, the heat insulating layer serves to reduce the extent of heat transfer to other region(s) of the film or label particularly during laser printing.

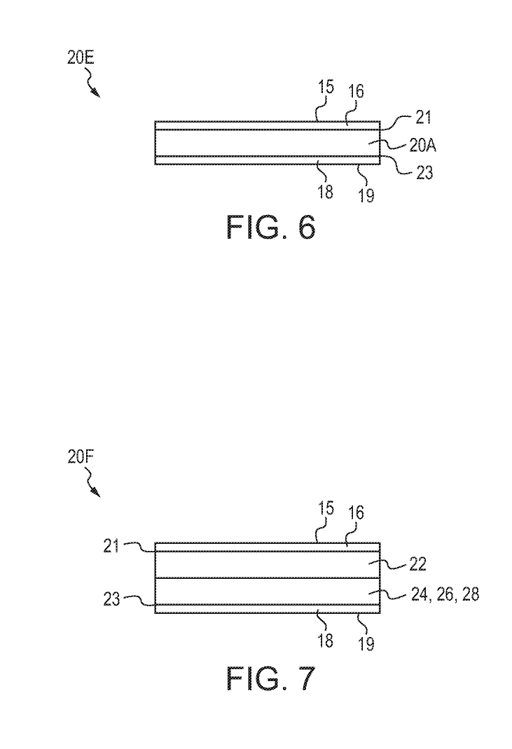

FIG. 6 illustrates a coated film 20E comprising a single layer film 20A defining a first outer film surface 21 and an oppositely directed second outer film surface 23. The coated film 20E also comprises a first coating 16 disposed on the first outer film surface 21 and an optional second coating 18 disposed on the second outer film surface 23. The first coating 16 provides an outer coating surface 15. The second coating 18 provides an outer coating surface 19.

FIG. 7 illustrates another coated film 20F comprising a multilayer film having layer 22 and one or more of layers 24, 26, and/or 28 as previously described. The multilayer film defines a first outer film surface 21 and an oppositely directed second outer film surface 23. The coated film 20F also comprises a first coating 16 disposed on the first outer film surface 21 and an optional second coating 18 disposed on the second outer film surface 23. The first coating 16 provides an outer coating surface 15. The second coating 18 provides an outer coating surface 19.

A wide array and variety of coatings can be used for the coating layers 16 and 18 in the coated films of FIGS. 6 and 7. The composition of the coating layers 16 and 18 can be the same as one another, or the composition of the coating layers can be different from each other.

In particular embodiments, one or both of the coating layers such as layers 16 and/or 18, include an ink receptive coating such as a topcoat as typically referred to in the industry. In other embodiments, one or both of the coating layers such as layers 16 and/or 18, include a heat insulating coating comprising porous silica particles, porous non-silica particles, and combinations thereof. In yet other embodiments, one or both of the coating layers such as layers 16 and/or 18, include a microporous foam coating. Additional details of these layers and other layers are as follows. It will be understood that the present subject matter includes coated films having one or more of these coatings in combination and/or in combination with other coatings and/or layers.

A wide variety of topcoats can be used. The topcoat can be an ink-receptive or adhesive-receptive material to include for example an acrylic primer or an abrasion or moisture resistant material to include for example a polyolefin or polyester where the coating can be applied in a liquid form and dried or allowed to dry. Additional details of topcoats and theft composition are provided in the description of label laminates of the present subject matter.

Various heat insulating coatings can be used. As previously noted, the heat insulating coating may comprise silica particles, other particles such as non-silica particles, and combinations thereof. In many embodiments, the particles are porous and in certain embodiments are highly porous. Known filler agents can potentially be used.

Representative thicknesses of the topcoats and the heat insulating coatings are from about 1 micron to about 250 microns, and in particular versions from 25 microns to 100 microns. However, it will be understood that the topcoats and/or the heat insulating coatings used in the present subject matter can have thicknesses greater than and/or lesser than these representative thicknesses. Many other variations of insulating material for the heat insulating coating can be used with the present subject matter. For instance, the heat insulating coating may comprise a foam. The foam may be polyurethane, or any other foam composition as known in the art. The heat insulating coating may compromise an inorganic fiber based material for example,

An array of microprous foam coatings can be used. In some embodiments, polymeric thermoplastic open cell or closed cell foams may be used. In some embodiments, the closed cell foams generally have at least about 5,000 closed cells per cubic inch (in³) (about 305 closed cells per cubic centimeter (cm³)), and less than about 250,000 closed cells per in (from about 305 to about 6,100 closed cells per cm³). In particular embodiments the closed cell density is from about 25,000 to about 75,000 closed cells per in³ (from about 1,525 to about 4,575 closed cells per cm³) and, in certain versions from about 40,000 to about 60,000 closed cells per in³ (from about 2,440 to about 3,660 closed cells per cm³). In some embodiments, the foam has a thickness of from about 10 microns to about 500 microns or more.

In some embodiments, the foam is a polypropylene microfoam available commercially under the designation MICROFOAM®, from Pactiv Corporation, Lake Forest, Ill. MICROFOAM® is a foam having approximately 50,000 closed cells per in³ (about 3,050 closed cells per cm³). Such a polypropylene microfoam, as with other foams, can be used alone or in combination, such as by lamination and coextrusion, with conventional label materials to form a coated film and/or label.

The microporous foam coating can also include open cell foams or foams having a combination of both closed cells and open cells.

Other materials useful for certain labels or sheets include, but are not limited to, foams of the type described herein that are coextruded with thermoplastic polymeric films that comprise a layer of the foam and a layer of the polymeric film material onto which indicia may be printed.

The various coatings can be applied to the films using known techniques such as but not limited to spraying, dipping, vapor deposition, roll to roll coating techniques, and spin coating for example.

### Label Laminates

As described herein, the label laminates of the present subject matter include a label face film which can be in the form of a single layer film or a multilayer film.

The label laminates also comprise a layer or region(s) of a pressure sensitive adhesive.

A description of useful pressure sensitive adhesives may be found in Encyclopedia of Polymer Science and Engineering, Vol. 13, Wiley-Interscience Publishers (New York, 1988). Additional description of useful PSAs may be found in Polymer Science and Technology, Vol. 1, Interscience Publishers (New York, 1964). Conventional PSAs, including acrylic-based PSAs, rubber-based PSAs and silicone-based PSAs are useful. The PSA may be a solvent based or may be a water based adhesive. Hot melt adhesives may also be used. In one embodiment, the PSA comprises an acrylic emulsion adhesive.

The adhesive and the side of the film to which the adhesive is applied have sufficient compatibility to enable good adhesive anchorage. In one embodiment, the adhesive is chosen so that the labels may be cleanly removed from PET containers up to 24 hours after application. The adhesive is also chosen so that the adhesive components do not migrate into the film.

In one embodiment, the adhesive may be formed from an acrylic based polymer. It is contemplated that any acrylic based polymer capable of forming an adhesive layer with sufficient tack to adhere to a substrate may function in the present subject matter. In certain embodiments, the acrylic polymers for the pressure sensitive adhesive layers include those formed from polymerization of at least one alkyl acrylate monomer containing from about 4 to about 12 carbon atoms in the alkyl group, and present in an amount from about 35-95% by weight of the polymer or copolymer, as disclosed in U.S. Pat. No. 5,264,532. Optionally, the acrylic based pressure sensitive adhesive might be formed from a single polymeric species.

The glass transition temperature of a PSA layer comprising acrylic polymers can be varied by adjusting the amount of polar, or “hard monomers”, in the copolymer, as taught by U.S. Pat. No. 5,264,532. The greater the percentage by weight of hard monomers is an acrylic copolymer, the higher the glass transition temperature. Hard monomers contemplated useful for the present subject matter include vinyl esters, carboxylic acids, and methacrylates, in concentrations by weight ranging from about zero to about thirty-five percent by weight of the polymer.

The PSA can be acrylic based such as those taught in U.S. Pat. No. 5,164,444 (acrylic emulsion), U.S. Pat. No. 5,623,011 (tackified acrylic emulsion) and U.S. Pat. No. 6,306,982. The adhesive can also be rubber-based such as those taught in U.S. Pat. No. 5,705,551 (rubber hot melt). The adhesive can also be radiation curable mixture of monomers with initiators and other ingredients such as those taught in U.S. Pat. No. 5,232,958 (UV cured acrylic) and U.S. Pat. No. 5,232,958 (EB cured). The adhesive can also be nearly any type of solvent based adhesive such as those described in U.S. Pat. No. 6,613,857 (UV crosslinked, acrylic solvent based adhesives), and U.S. Pat. No. 4,994,538 (silicone solvent based adhesives).

Commercially available PSAs are useful in the present subject matter. Examples of these adhesives include the hot melt PSAs available from H. B. Fuller Company, St. Paul, Minn. as HM-1597, HL-2207-X, HL-2115-X, HL-2193-X. Other useful commercially available PSAs include those available from Century Adhesives Corporation, Columbus, Ohio. Another useful acrylic PSA comprises a blend of emulsion polymer particles with dispersion tackifier particles as generally described in Example 2 of U.S. Pat. No. 6,306,982. The polymer is made by emulsion polymerization of 2-ethylhexyl acrylate, vinyl acetate, dioctyl maleate, and acrylic and methacrylic comonomers as described in U.S. Pat. No. 5,164,444 resulting in the latex particle size of about 0.2 microns in weight average diameters and a gel content of about 60%.

A commercial example of a hot melt adhesive is H2187-01, sold by Ato Findley, Inc., of Wauwatusa, Wis. In addition, rubber based block copolymer PSAs described in U.S. Pat. No. 3,239,478 also can be utilized in the adhesive constructions of the present subject matter.

In another embodiment, the pressure sensitive adhesive comprises rubber based elastomer materials containing useful rubber based elastomer materials include linear, branched, grafted, or radial block copolymers represented by the diblock structure A-B, the triblock A-B-A, the radial or coupled structures (A-B)n, and combinations of these where A represents a hard thermoplastic phase or block which is non-rubbery or glassy or crystalline at room temperature but fluid at higher temperatures, and B represents a soft block which is rubbery or elastomeric at service or room temperature. These thermoplastic elastomers may comprise from about 75% to about 95% by weight of rubbery segments and from about 5% to about 25% by weight of non-rubbery segments.

The non-rubbery segments or hard blocks comprise polymers of mono- and polycyclic aromatic hydrocarbons, and more particularly vinyl-substituted aromatic hydrocarbons that may be monocyclic or bicyclic in nature. Rubbery materials such as polyisoprene, polybutadiene, and styrene butadiene rubbers may be used to form the rubbery block or segment. Particularly useful rubbery segments include polydienes and saturated olefin rubbers of ethylene/butylene or ethylene/propylene copolymers. The latter rubbers may be obtained from the corresponding unsaturated polyalkylene moieties such as polybutadiene and polyisoprene by hydrogenation thereof.

The block copolymers of vinyl aromatic hydrocarbons and conjugated dienes that may be utilized include any of those that exhibit elastomeric properties. The block copolymers may be diblock, triblock, multiblock, starblock, polyblock or graftblock copolymers. Throughout this specification, the terms diblock, triblock, multiblock, polyblock, and graft or grafted-block with respect to the structural features of block copolymers are to be given their normal meaning as defined in the literature such as in the Encyclopedia of Polymer Science and Engineering, Vol. 2, (1985) John Wiley & Sons, Inc., New York, pp. 325-326, and by J. E. McGrath in Block Copolymers, Science Technology, Dale J. Meier, Ed., Harwood Academic Publishers, 1979, at pages 1-5.

Such block copolymers may contain various ratios of conjugated dienes to vinyl aromatic hydrocarbons including those containing up to about 40% by weight of vinyl aromatic hydrocarbon. Accordingly, multi-block copolymers may be utilized which are linear or radial symmetric or asymmetric and which have structures represented by the formulae A-B, A-B-A, A-B-A-B, B-A-B, (AB)0, 1, 2 . . . BA, etc., wherein A is a polymer block of a vinyl aromatic hydrocarbon or a conjugated diene/vinyl aromatic hydrocarbon tapered copolymer block, and B is a rubbery polymer block of a conjugated diene.

The block copolymers may be prepared by any of the well known block polymerization or copolymerization procedures including sequential addition of monomer, incremental addition of monomer, or coupling techniques as illustrated in, for example, U.S. Pat. Nos. 3,251,905; 3,390,207; 3,598,887; and 4,219,627. As well known, tapered copolymer blocks can be incorporated in the multi-block copolymers by copolymerizing a mixture of conjugated diene and vinyl aromatic hydrocarbon monomers utilizing the difference in their copolymerization reactivity rates. Various patents describe the preparation of multi-block copolymers containing tapered copolymer blocks including U.S. Pat. Nos. 3,251,905; 3,639,521; and 4,208,356.

Conjugated dienes that may be utilized to prepare the polymers and copolymers are those containing from 4 to about 10 carbon atoms and more generally, from 4 to 6 carbon atoms. Examples include from 1,3-butadiene, 2-methyl-1,3-butadiene(isoprene), 2,3-dimethyl-1,3-butadiene, chloroprene, 1,3-pentadiene, 1,3-hexadiene, etc. Mixtures of these conjugated dienes also may be used.

Examples of vinyl aromatic hydrocarbons which may be utilized to prepare the copolymers include styrene and the various substituted styrenes such as o-methylstyrene, p-methylstyrene, p-tert-butylstyrene, 1,3-dimethylstyrene, alpha-methylstyrene, beta-methylstyrene, p-isopropylstyrene, 2,3-dimethylstyrene, o-chlorostyrene, p-chlorostyrene, o-bromostyrene, 2-chloro-4-methylstyrene, etc.

Many of the above-described copolymers of conjugated dienes and vinyl aromatic compounds are commercially available. The number average molecular weight of the block copolymers, prior to hydrogenation, is from about 20,000 to about 500,000, or from about 40,000 to about 300,000.

The average molecular weights of the individual blocks within the copolymers may vary within certain limits. In most instances, the vinyl aromatic block will have a number average molecular weight in the order of about 2000 to about 125,000, or between about 4000 and 60,000. The conjugated diene blocks either before or after hydrogenation will have number average molecular weights in the order of about 10,000 to about 450,000, or from about 35,000 to 150,000.

Also, prior to hydrogenation, the vinyl content of the conjugated diene portion generally is from about 10% to about 80%, or from about 25% to about 65%, particularly 35% to 55% when it is desired that the modified block copolymer exhibit rubbery elasticity. The vinyl content of the block copolymer can be measured by means of nuclear magnetic resonance.

Specific examples of diblock copolymers include styrene-butadiene (SB), styrene-isoprene (SI), and the hydrogenated derivatives thereof. Examples of triblock polymers include styrene-butadiene-styrene (SBS), styrene-isoprene-styrene (SIS), alpha-methylstyrene-butadiene-alpha-methylstyrene, and alpha-methylstyrene-isoprene alpha-methylstyrene. Examples of commercially available block copolymers useful as the adhesives in the present subject matter include those available from Kraton Polymers LLC under the KRATON trade name.

Upon hydrogenation of the SBS copolymers comprising a rubbery segment of a mixture of 1,4 and 1,2 isomers, a styrene-ethylene-butylene styrene (SEBS) block copolymer is obtained. Similarly, hydrogenation of an SIS polymer yields a styrene-ethylene propylene-styrene (SEPS) block copolymer.

The selective hydrogenation of the block copolymers may be carried out by a variety of well known processes including hydrogenation in the presence of such catalysts as Raney nickel, noble metals such as platinum, palladium, etc., and soluble transition metal catalysts. Suitable hydrogenation processes which can be used are those wherein the diene-containing polymer or copolymer is dissolved in an inert hydrocarbon diluent such as cyclohexane and hydrogenated by reaction with hydrogen in the presence of a soluble hydrogenation catalyst. Such procedures are described in U.S. Pat. Nos. 3,113,986 and 4,226,952. Such hydrogenation of the block copolymers which are carried out in a manner and to extent as to produce selectively hydrogenated copolymers having a residual unsaturation content in the polydiene block of from about 0.5% to about 20% of their original unsaturation content prior to hydrogenation.

In one embodiment, the conjugated diene portion of the block copolymer is at least 90% saturated and more often at least 95% saturated while the vinyl aromatic portion is not significantly hydrogenated. Particularly useful hydrogenated block copolymers are hydrogenated products of the block copolymers of styrene-isoprene-styrene such as a styrene-(ethylene/propylene)-styrene block polymer. When a polystyrene-polybutadiene-polystyrene block copolymer is hydrogenated, it is desirable that the 1,2-polybutadiene to 1,4-polybutadiene ratio in the polymer is from about 30:70 to about 70:30. When such a block copolymer is hydrogenated, the resulting product resembles a regular copolymer block of ethylene and 1-butene (EB). As noted above, when the conjugated diene employed as isoprene, the resulting hydrogenated product resembles a regular copolymer block of ethylene and propylene (EP).

A number of selectively hydrogenated block copolymers are available commercially from Kraton Polymers under the general trade designation “Kraton G.” One example is Kraton G1652 which is a hydrogenated SBS triblock comprising about 30% by weight of styrene end blocks and a midblock which is a copolymer of ethylene and 1-butene (EBY A lower molecular weight version of G1652 is available under the designation Kraton G1650. Kraton G1651 is another SEBS block copolymer which contains about 33% by weight of styrene. Kraton G1657 is an SEBS diblock copolymer which contains about 13% by weight styrene. This styrene content is lower than the styrene content in Kraton G1650 and Kraton G1652.

In another embodiment, the selectively hydrogenated block copolymer is of the formula:

Bₙ(AB)ₒAₚ

wherein n=0 or 1; o is 1 to 100; p is 0 or 1; each B prior to hydrogenation is predominantly a polymerized conjugated diene hydrocarbon block having a number average molecular weight of about 20,000 to about 450,000; each A is predominantly a polymerized vinyl aromatic hydrocarbon block having a number average molecular weight of from about 2000 to about 115,000; the blocks of A constituting about 5% to about 95% by weight of the copolymer; and the unsaturation of the block B is less than about 10% of the original unsaturation. In other embodiments, the unsaturation of block B is reduced upon hydrogenation to less than 5% of its original value, and the average unsaturation of the hydrogenated block copolymer is reduced to less than 20% of its original value.

The block copolymers may also include functionalized polymers such as may be obtained by reacting an alpha, beta-olefinically unsaturated monocarboxylic or dicarboxylic acid reagent onto selectively hydrogenated block copolymers of vinyl aromatic hydrocarbons and conjugated dienes as described above. The reaction of the carboxylic acid reagent in the graft block copolymer can be effected in solutions or by a melt process in the presence of a free radical initiator.

The preparation of various selectively hydrogenated block copolymers of conjugated dienes and vinyl aromatic hydrocarbons which have been grafted with a carboxylic acid reagent is described in a number of patents including U.S. Pat. Nos. 4,578,429; 4,657,970; and 4,795,782. These patents describe grafted selectively hydrogenated block copolymers of conjugated dienes and vinyl aromatic compounds, and the preparation of such compounds. U.S. Pat. No. 4,795,782 describes and gives examples of the preparation of the grafted block copolymers by the solution process and the melt process. U.S. Pat. No. 4,578,429 contains an example of grafting of Kraton G1652 (SEBS) polymer with maleic anhydride with 2,5-dimethyl-2,5-di(t-butylperoxy)hexane by a melt reaction in a twin screw extruder.

Examples of commercially available maleated selectively hydrogenated copolymers of styrene and butadiene include Kraton FG1901X, FG1921X, and FG1924X, often referred to as maleated selectively hydrogenated SEBS copolymers. FG1901X contains about 1.7% by weight bound functionality as succinic anhydride and about 28% by weight of styrene. FG1921X contains about 1% by weight of bound functionality as succinic anhydride and 29% by weight of styrene. FG1924X contains about 13% styrene and about 1% bound functionality as succinic anhydride.

Useful block copolymers also are available from Nippon Zeon Co., 2-1, Marunochi, Chiyoda-ku, Tokyo, Japan. For example, Quintac 3530 is available from Nippon Zeon and is believed to be a linear styrene-isoprene-styrene block copolymer.

Unsaturated elastomeric polymers and other polymers and copolymers which are not inherently tacky can be rendered tacky when compounded with an external tackifier. Tackifiers, are generally hydrocarbon resins, wood resins, rosins, rosin derivatives, and the like, which when present in concentrations ranging from about 40% to about 90% by weight of the total adhesive composition, or from about 45% to about 85% by weight, impart pressure sensitive adhesive characteristics to the adhesive formulation. Compositions containing less than about 40% by weight of tackifier additive do not generally show sufficient “quickstick,” or initial adhesion, to function as a pressure sensitive adhesive, and therefore are not inherently tacky. Compositions with too high a concentration of tackifying additive, on the other hand, generally show too little cohesive strength to work properly in most intended use applications of constructions made in accordance with the present subject matter.

It is contemplated that any tackifier known by those of skill in the art to be compatible with elastomeric polymer compositions may be used with the present subject matter. One such tackifier, found useful is Wingtak 10, a synthetic polyterpene resin that is liquid at room temperature, and sold by the Goodyear Tire and Rubber Company of Akron, Ohio. Wingtak 95 is a synthetic tackifier resin also available from Goodyear that comprises predominantly a polymer derived from piperylene and isoprene. Other suitable tackifying additives may include Escorez 1310, an aliphatic hydrocarbon resin, and Escorez 2596, a C5-C9 (aromatic modified aliphatic) resin, both manufactured by Exxon of Irving, Tex. A variety of different tackifying additives may be used to practice the present subject matter.

In addition to the tackifiers, other additives may be included in the PSAs to impart desired properties. For example, plasticizers may be included, and they are known to decrease the glass transition temperature of an adhesive composition containing elastomeric polymers. An example of a useful plasticizer is Shellflex 371, a naphthenic processing oil available from Shell Lubricants of Texas. Antioxidants also may be included on the adhesive compositions. Suitable antioxidants include Irgafos 168 and Irganox 565 available from Ciba-Geigy, Hawthorne, N.Y. Cutting agents such as waxes and surfactants also may be included in the adhesives.

The pressure sensitive adhesive may be applied from a solvent, emulsion or suspension, or as a hot melt. The adhesive may be applied to the inner surface of the film by any known method. For example, the adhesive may be applied by die coating curtain coating, spraying, dipping, rolling, gravure or flexographic techniques. The adhesive may be applied to the film in a continuous layer, a discontinuous layer or in a pattern. The pattern coated adhesive layer substantially covers the entire inner surface of the film. As used herein, “substantially covers” is intended to mean the pattern in continuous over the film surface, and is not intended to include adhesive applied only in a strip along the leading or trailing edges of the film or as a “spot weld” on the film.

The label laminates also include a release liner. The release liner includes a paper and/or film substrate and one or more release agents deposited on the paper and/or film substrate.

A wide variety of release materials such as those typically used for pressure sensitive tapes and labels are known, including silicones, alkyds, stearyl derivatives of vinyl polymers (such as polyvinyl stearyl carbamate), stearate chromic chloride, stearamides and the like. Fluorocarbon polymer coated release liners are also known but are relatively expensive. A film skin layer can be modified by adding one or more slip agent(s) including a silicone type slip agent during the film coextruding process. The release layer can be provided by the slip agent modified film skin layer. More particularly, the release layer can be in the form of a silicone slip agent modified coextruded polypropylene film skin layer. For most pressure sensitive adhesive applications, silicones are by far the most frequently used materials. Silicone release coatings have easy release at both high and low peel rates, making them suitable for a variety of production methods and applications.

Known silicone release coating systems include a reactive silicone polymer, e.g., an organopolysiloxane (often referred to as a “polysiloxane,” or simply, “siloxane”); a cross-linker; and a catalyst. After being applied to the adjacent layer or other substrate, the coating generally must be cured to cross-link the silicone polymer chains, either thermally or radiatively (by, e.g., ultraviolet or electron beam irradiation).

Based on the manner in which they are applied, three basic types of silicone release coatings used in the pressure sensitive adhesive industry are known: solventborne, waterborne emulsions, and solvent free coatings. Each type has advantages and disadvantages. Solventborne silicone release coatings have been used extensively but, because they employ a hydrocarbon solvent, their use in recent years has tapered off due to increasingly strict air pollution regulations, high energy requirements, and high cost. Indeed, the energy requirements of solvent recovery or incineration generally exceed that of the coating operation itself.

Waterborne silicone emulsion release systems are as well known as solvent systems, and have been used on a variety of pressure sensitive products, including tapes, floor tiles, and vinyl wall coverings. Their use has been limited, however, by problems associated with applying them to paper substrates. Water swells paper fibers, destroying the dimensional stability of the release liner backing and causing sheet curling and subsequent processing difficulties.

Solventless silicone release coatings have grown in recent years and now represent a major segment of the silicone release coating market. Like other silicone coatings, they must be cured after being applied to the flexible liner substrate. Curing produces a cross-linked film that resists penetration by the pressure sensitive adhesive.

Informative descriptions of various release materials, their characteristics, and incorporation in laminate assemblies are provided in U.S. Pat. Nos. 5,728,469; 6,486,267; and US Published Patent Application 2005/0074549. It is also contemplated that various waxes known in the art could be used for the release material or utilized in the release layer.

The label laminates can also include one or more optional coatings and/or topcoats.

In particular applications in accordance with the present subject matter, the labels or label laminates are printed using a variety of printing technologies instead, or in addition to, laser printing. Nonlimiting examples of such other printing technologies include inkjet printing, flexo printing, gravure printing, thermal transfer printing, screen printing, bar code printing, and others. Combinations of these printing technologies can be utilized with or without laser printing in association with the present subject matter.

The labels of the present subject matter may also contain a layer of an ink-receptive composition that enhances the printability of the label face film, and the quality of the print layer thus obtained. A variety of such compositions are known in the art, and these compositions generally include a binder and a pigment, such as silica or talc, dispersed in the binder. The presence of the pigment decreases the drying time of some inks. Such ink-receptive compositions are described in U.S. Pat. Nos. 6,153,288, and 7,153,554 (laser printable coatings).

The print layer may be an ink or graphics layer, and the print layer may be a mono-colored or multi-colored print layer depending on the printed message and/or the intended pictorial design. These include variable imprinted data such as serial numbers, bar codes, trademarks, etc. The thickness of the print layer is typically in the range of about 0.5 to about 10 microns, and in one embodiment about 1 to about 5 microns, and in another embodiment about 3 microns. The inks used in the print layer include commercially available water-based, solvent-based or radiation-curable inks. Examples of these inks include Sun Sheen (a product of Sun Chemical identified as an alcohol dilutable polyamide ink), Suntex MP (a product of Sun Chemical identified as a solvent-based ink formulated for surface printing acrylic coated substrates, PVDC coated substrates and polyolefin films), X-Cel (a product of Water Ink Technologies identified as a water-based film ink for printing film substrates), Uvilith AR-109 Rubine Red (a product of Daw Ink identified as a UV ink) and CLA91598F (a product of Sun Chemical identified as a multibond black solvent-based ink), Lexmark laser printer or toner inks, and Xerox laser printer or toner inks.

In one embodiment, the print layer comprises a polyester/vinyl ink, a polyamide ink, an acrylic ink and/or a polyester ink. The print layer may be formed in the conventional manner by, for example, gravure, flexographic or UV flexographic printing or the like, an ink composition comprising a resin of the type described above, a suitable pigment or dye and one or more suitable volatile solvents onto one or more desired areas of the film. After application of the ink composition, the volatile solvent component(s) of the ink composition evaporate(s), leaving only the non-volatile ink components to form the print layer.

The adhesion of the ink to the surface of the polymeric film can be improved, if necessary, by techniques well known to those skilled in the art. For example, as mentioned above, an ink primer or other ink adhesion promoter can be applied to the polymeric film layer or other underlying layer before application of the ink. Alternatively the surface of the polymeric film can be corona treated or flame treated to improve the adhesion of the ink to the polymeric film layer.

Useful ink primers may be transparent or opaque and the primers may be solvent based or water-based. In one embodiment, the primers are radiation curable (e.g., UV). The ink primer may comprise a lacquer and a diluent. The lacquer may be comprised of one or more polyolefins, polyamides, polyesters, polyester copolymers, polyurethanes, polysulfones, polyvinylidine chloride, styrene-maleic anhydride copolymers, styrene-acrylonitrile copolymers, ionomers based on sodium or zinc salts or ethylene methacrylic acid, polymethyl methacrylates, acrylic polymers and copolymers, polycarbonates, polyacrylonitriles, ethylene-vinyl acetate copolymers, and mixtures of two or more thereof. Examples of the diluents that can be used include alcohols such as ethanol, isopropanol and butanol; esters such as ethyl acetate, propyl acetate and butyl acetate; aromatic hydrocarbons such as toluene and xylene; ketones such as acetone and methyl ethyl ketone; aliphatic hydrocarbons such as heptane; and mixtures thereof. The ratio of lacquer to diluent is dependent on the viscosity required for application of the ink primer, the selection of such viscosity being within the skill of the art. The ink primer layer may have a thickness of from about 1 to about 4 microns or from about 1.5 to about 3 microns.

A transparent polymer protective topcoat or overcoat layer may be present in the labels of the present subject matter. The protective topcoat or overcoat layer provides desirable properties to the label before and after the label is affixed to a substrate. The presence of a transparent topcoat layer over the print layer may, in some embodiments provide additional properties such as antistatic properties stiffness and/or weatherability, and the topcoat may protect the print layer from, e.g., weather, sun, abrasion, moisture, water, etc. The transparent topcoat layer can enhance the properties of the underlying print layer to provide a glossier and richer image. The protective transparent protective layer may also be designed to be abrasion resistant, radiation resistant (e.g., UV), chemically resistant, thermally resistant thereby protecting the label and, particularly the print layer from degradation from such causes. The protective overcoat may also contain antistatic agents, or anti-block agents to provide for easier handling when the labels are being applied to containers at high speeds. The protective layer may be applied to the print layer by techniques known to those skilled in the art. The polymer film may be deposited from a solution, applied as a preformed film (laminated to the print layer), etc.

When a transparent topcoat or overcoat layer is present, it may have a single layer or a multilayered structure. The thickness of the protective layer is generally in the range of about 12.5 to about 125 microns, and in one embodiment about 25 to about 75 microns. Examples of the topcoat layers are described in U.S. Pat. No. 6,106,982.

The protective layer may comprise polyolefins, thermoplastic polymers of ethylene and propylene, polyesters, polyurethanes, polyacryls, polymethacryls, epoxy, vinyl acetate homopolymers, co- or terpolymers, ionomers, and mixtures thereof.

The transparent protective layer may contain UV light absorbers and/or other light stabilizers. Among the UV light absorbers that are useful are the hindered amine absorbers available from Ciba Specialty Chemical under the trade designations “Tinuvin”. The light stabilizers that can be used include the hindered amine light stabilizers available from Ciba Specialty Chemical under the trade designations Tinuvin 111, Tinuvin 123, (bis-(1-octyloxy-2,2,6,6-tetramethyl-4-piperidinyl)sebacate; Tinuvin 622, (a dimethyl succinate polymer with 4-hydroxy-2,2,6,6-tetramethyl-1-piperidniethanol); Tinuvin 770 (bis-(2,2,6,6-tetramethyl-4-piperidinyl)-sebacate); and Tinuvin 783. Additional light stabilizers include the hindered amine light stabilizers available from Ciba Specialty Chemical under the trade designation “Chemassorb”, especially Chemassorb 119 and Chemassorb 944. The concentration of the UV light absorber and/or light stabilizer is in the range of up to about 2.5% by weight, and in one embodiment about 0.05% to about 1% by weight.

The transparent protective layer may contain an antioxidant. Any antioxidant useful in making thermoplastic films can be used. These include the hindered phenols and the organo phosphites. Examples include those available from Ciba Specialty Chemical under the trade designations Irganox 1010, Irganox 1076 or Irgafos 168. The concentration of the antioxidant in the thermoplastic film composition may be in the range of up to about 2.5% by weight, and in one embodiment about 0.05% to about 1% by weight.

In certain embodiments or applications, it may be useful to include a varnish or topcoat layer over a print or toner layer. The present subject matter includes a wide array of layer combinations including the use of “over-lam” or overlaminate layers as known in the art.

### EXAMPLES

### Film Extrusion Process

In the examples herein, various label face films were prepared by using a multilayer conventional coextrusion cast process equipped with four extruders A, B, C, D and a feed block capable of providing up to seven (7) layers. Each extruder supplied a melt formulation to a symmetric feed block (feed block structure ABCDCBA) where the melts were combined to form a single molten stream having a multilayer arrangement. The molten stream was cast onto a cast roll, solidified, and transported to a set of rollers and wound into a film roll. The resin formulation in extruders A, B, C, D was the same or different based on the film layer structure. For example, a single layer film was made by feeding all extruders A, B, C, D the same resin formulation and a three layer symmetric film was made by feeding extruder A the same resin formulation as B and feeding extruder C the same resin as extruder D. A valve is provided in the feed block for each layer which can be turned off so a nonsymmetric film structure can be made. The layer thickness ratio of the multilayer film was controlled via the ratios of molten material to each extruder.

In the coextruded film examples, the film layer structure formulation is described by the format presented in Table 4A. For example, “(80% HPP+20% LLDPE)/(100% LLDPE)/(80% HPP+20% LLDPE)” and “10/80/10” in example B-1 represents a 3 layer film with a blend of 80% HPP and 20% LLDPE in layer 1, 100% LLDPE in layer 2, and a blend of 80% HPP and 20% LLDPE in layer 3. And the layer thickness percentage of each layer based upon the total thickness is 10% for layer 1, 80% for layer 2, and 10% for layer 3.

### Laminate Process

The various label laminates used in the examples were prepared by laminating pressure sensitive adhesive and release liner on the label face via a laminator. The pressure sensitive adhesive used in the examples is AVERY DENNISON LR-180 emulsion based adhesive. The release liner used is silicone coated 85# paper release liner with polyethylene coating on the back to provide a moisture barrier. In the lamination, machine direction of the label film is same direction as the machine direction of the release liner.

### Laser Printer Post Print “Layflat” Test

The laser printer used to test post print “layflat” characteristics in the examples was a Lexmark T644 laser printer. In the print test, the sample is in laminate form. The laminate was die cut into 8.5 inch by 11 inch size sheet and fed through the laser printer. The printed sheet was placed on a table with print side face up. The curl height of the four corners of the print sheet was measured by a ruler after the printed sheet was cooled and reached a maximum curl height within 2 minutes. The average value of curl height at four corners was recorded as the curl height for the sample. Usually, within 1 hour to 24 hours after printing the post print curl height will gradually decrease as the materials of the laminate relax. The extent of such relaxation depends on the material. But in practice, the curl height immediately after print is critical.

In many embodiments of the present subject matter, sheets of print media or label laminate as described herein, exhibit an average curl height of less than 2.0 inches, in certain embodiments less than 1.5 inches, in particular embodiments less than 1.0 inches, and in still other embodiments less than 0.5 inches. These average curl heights are measured after printing in the previously noted Lexmark T644 laser printer using a sheet having a size of 8.5 inch by 11 inch and by averaging maximum curl heights at each corner within 2 minutes after printing.

### Laser Printer Jamming Melt Down Test

This is to evaluate whether a label laminate jammed in a laser printer, can be pulled out as an integral piece without film breakage. This is a critical test. During typical printing, the contact time between the hot fuser roll and print media is about 0.5 second or less. However, if media becomes jammed, media is located under the hot fuser roll and the temperature of the media quickly rises. For certain dwelling times, the label film becomes very soft and may melt depending on the melting temperature of the media. If one or more film piece(s) are left insider the printer, it may be necessary to disassemble or otherwise service the printer to remove the torn or severed sheet or film piece(s). As will be appreciated, printer disassembly and/or service is undesirable since it is time consuming and may require trained personnel. In this test, the laminate is forced to jam in the printer for 2 minutes, then removed from the printer to check whether the laminate is still intact. Any piece or sheet fragment left inside printer is considered a fail.

### Label Converting Test

Many applications of the present subject matter involve label application. Thus, it is important for the label laminate to exhibit suitable properties such as those required in typical label converting processes especially involving label die cutting, matrix striping, perforation, sheeting etc. A roll form laminate with a particular formulation was evaluated in a label converting press with die cutting, perforating, matrixes tripping, and sheeting modules.

Table 1 lists the general name, supplier, grade and other information of polymers used in making extruded film in the examples.

TABLE 1
Extruded Film Polymers Used in Examples

| Code | General Chemical Name | Supplier | Grade | Tg | Melt Point, Tm |
|---|---|---|---|---|---|
| HPP | homo polypropylene | Flint Hills | P4G3Z-050F | approx. −10° C. | approx. 165° C. |
| | | resources | | | |
| RCP | Polypropylene and | Flint Hills | 43S2A | Below −10° C. | Deflection |
| | Polyethylene random | resources | | | Temperature |
| | copolymer | | | | approx. 79° C. |
| LLDPE | Liner low density | Dow | Dowlex | approx. 110° C. | approx. 121° C. |
| | polyethylene | chemical | 2056G | | |
| EVA-18 | Polyethylene vinyl acetate | Celanese | Ateva 1821 | approx. −20° C. | approx. 87° C. |
| | with 18% vinyl acetate | | | | |
| SEBS | styrene- | Kraton | G2832 | Tg of soft phase | |
| | ethylene/butylenes- | polymers | | below 0° C. | |
| | styrene (SEBS) block | | | | |
| | copolymer | | | | |
| COC-13 | Cyclic olefin copolymer | Topas | Topas 6013F | approx. 138° C. | N/A |
| | | advanced | | | |
| | | polymers | | | |
| COC-03 | Cyclic olefin copolymer | Topas | TOPAS | approx. 33° C. | N/A |
| | | advanced | 9903D | | |
| | | polymers | | | |
| COC-07 | Cyclic olefin copolymer | Topas | TOPAS 8007 | approx. 78° C. | N/A |
| | | advanced | | | |
| | | polymers | | | |
| HIPS | High impact modified | Styrolution | Styrneic | approx. 83° C. | N/A |
| | polystyrene | | 5410 | | |
| GPPS | General purpose | Americas | GPPS EA | approx. 99° C. | N/A |
| | polystyrene | styrenics | 3400 | | |

Table 2 lists the structure of different cast polyolefin films and their post print curl after incorporation in a label laminate. The thicknesses of the films are all about 3 mil (75 micron) unless stated otherwise in the table. Table 2 reveals that both a single extruded layer film of polypropylene or polyethylene or a blend of them, and their coextruded films exhibit severe post print curl. Sample A-3 (LLDPE) and Sample A-5 (EVA-18) do not have sufficient heat resistance.

TABLE 2
Various Cast Polyolefin Films

| | | | Laminate Post | |
|---|---|---|---|---|
| | Film | | Print Curl Height | Print Jam Melt |
| Example ID | Structure | Film Formulation | (inches) | Down Test |
| Example A-1 | Single layer | HPP | >3, tube up | Pass |
| Example A-2 | Single layer | RCP | >3, tube up | Pass |
| Example A-3 | Single layer | LLDPE | Printer jam, | Fail |
| | | | can't print | |
| Example A-4 | Single layer | HDPE | >3, tube up | Pass |
| Example A-5 | Single layer | EVA-18 | Printer jam, | Fail |
| | | | can't print | |
| Example A-6 | Single layer | Blend of 75% HPP and 25% LLDPE | >3, tube up | Pass |
| Example A-7 | Single layer | Blend of 50% HPP and 50% LLDPE | >3, tube up | Pass |
| Example A-8 | Single layer | Blend of 25% HPP and 75% LLDPE | >3, tube up | Pass |
| Example A-9 | Two layer | 100% HPP in layer 1 and 100% | >3, tube up | Pass |
| | | LLDPE in layer 2 with Layer with | | |
| | | layer 1: layer 2 thickness ratio | | |
| | | 75:25 | | |
| Example A-10 | Two layer | 100% HPP in layer 1 and 100% | >3, tube up | Pass |
| | | LLDPE in layer 2 with Layer with | | |
| | | layer 1: layer 2 thickness ratio | | |
| | | 50:50 | | |
| Example A-11 | Two layer | 100% HPP in layer 1 and 100% | >3, tube up | Pass |
| | | LLDPE in layer 2 with Layer with | | |
| | | layer 1: layer 2 thickness ratio | | |
| | | 25:75 | | |
| Example A-12 | Single layer | Blend of 50% HPP with 50% EVA-18 | >3, tube up | Pass |

Table 3 shows post print layflat characteristics of commercially available films, including polyolefin based films. Some films are biaxially oriented instead of formed using a cast process. None of the films exhibited an acceptable post print layflat property. The average curl height of 1.5 inch or less is close to an acceptable level in practice. The exact acceptable limit depends on the particular application.

TABLE 3
Commercially Available Films

| | | | | Print Jam |
|---|---|---|---|---|
| | Film Grade and | Film Structure | Laminate Post Print | Melt Down |
| Example ID | Supplier | Description | Curl Height (inches) | Test |
| Example A-13 | 2.0 mil Jindal 50WL359 | Biaxial oriented low | approx. 2.5 | Pass |
| | BOPP | shrink polypropylene | | |
| | | film | | |
| Example A-14 | 40 micron cast PLA | Single layer Polylactic | approx. 2, tube up | Fail |
| | film from Triniflex | acid film | | |
| Example A-15 | 3.0 mil White PP film | Single layer | >3, tube up | Pass |
| | from American Profol | polypropylene film | | |
| | | with TiO2 pigment | | |
| | | inside | | |
| Example A-16 | EWR 57 from Treofan | coextruded OPP film | approx. 2.5 tube up | Pass |
| Example A-17 | 3 mil PP/PE | PP/PE coextruded film | >3, tube up | Pass |
| | coextruded film from | | | |
| | performance | | | |
| | packaging | | | |

Table 4A lists the post print curl characteristics of coextruded film with EVA-18 and LLDPE blend in the core layer. EVA-18 has impact on the post print layflat properties of film. As the loading of EVA-18 increases, the curl height post print decreases. However, as shown in Table 4B the printer jam melt down properties deteriorate as EVA-18 loading increases since EVA-18 is a very soft material with a low degree of crystallinity. See the change from Example B-1 to B-5 and from Example B-6 to B-9. Example B-5 and Example B-9 have acceptable post layflat performance, but do not have enough heat resistance to prevent the film melt breakage in the printer if jamming occurs.

TABLE 4A
Post Print Curl Characteristics of Various Films

| | | Layer Structure: | |
|---|---|---|---|
| | | layer 1/layer 2/layer 3 for 3 layer film; | |
| | | layer 1/layer 2/layer 3/layer 4/layer 5 for 5 layer film | |
| | Number | | Layer Thickness |
| Example ID | of Layers | Formulation in Each Layer | % of Each Layer |
| Example B-1 | 3 layer | (80% HPP + 20% LLDPE)/(100% LLDPE)/(80% HPP + 20% LLDPE) | 10/80/10 |
| Example B-2 | 3 layer | (80% HPP + 20% LLDPE)/(70% LLDPE + 30% EVA- | 10/80/10 |
| | | 18)/(80% PP + 20% LLDPE) | |
| Example B-3 | 3 layer | (80% HPP + 20% LLDPE)/(50% LLDPE + 50% EVA- | 10/80/10 |
| | | 18)/(80% HPP + 20% LLD PE) | |
| Example B-4 | 3 layer | (50% HPP + 50% LLDPE)/(70% LLDPE + 30% EVA- | 10/80/10 |
| | | 18)/(50% HPP + 50% LLDPE) | |
| Example B-5 | 3 layer | (100% LLDPE)/(70% LLDPE + 30% EVA-18)/(100% LLDPE) | 10/80/10 |
| Example B-6 | 5 layer | (100% | 10/10/60/10/10 |
| | | HPP)/(50% HPP + 50% LLDPE)/(100% LLDPE)/(50% HPP + 50% LL | |
| | | DPE)/ (100% HPP) | |
| Example B-7 | 5 layer | (100% HPP)/(50% HPP + 50% LLDPE)/(70% PE + 30% EVA- | 10/10/60/10/10 |
| | | 18)/(50% HPP + 50% LLDPE)/(100% HPP) | |
| example B-8 | 5 layer | (100% HPP)/(50% HPP + 50% LLDPE)/(50% PE + 50% EVA- | 10/10/60/10/10 |
| | | 18)/(50% HPP + 50% LLDPE)/(100% HPP) | |
| example B-9 | 5 layer | (100% HPP)/(50% HPP + 50% LLDPE)/(100% EVA- | 10/10/60/10/10 |
| | | 18)/(50% HPP + 50% LLDPE)/(100% HPP) | |

TABLE 4B
Print Jam Melt Down Test of Various Films

| | | Print Jam Melt |
|---|---|---|
| Example ID | Laminate Post Print Curl Height (inches) | Down Test |
| Example B-1 | >3.0 | Pass |
| Example B-2 | approx. 2.5 | Pass |
| Example B-3 | approx. 1.5 | Fail |
| Example B-4 | approx. 1.5 | Fail |
| Example B-5 | approx. 1.0 | Fail |
| Example B-6 | >3.0 | Pass |
| Example B-7 | approx. 2.0 | Pass |
| Example B-8 | approx. 1.5 | Fail |
| Example B-9 | approx. 1.0 | Fail |

Table 5 lists the post print curl height of single layer film or multilayer coextruded film containing blend of 80% COC-13 and 20% LLDPE in the core or interior layer. The post print curl results indicate that the curl height is significantly reduced after adding COC-13 in the core layer. The curl height is also related to the thickness of core layer as well the material used in the other layer(s).

TABLE 5
Curl Height of Various Films

| | Number | | | |
|---|---|---|---|---|
| | of | | Layer Thickness % | Laminate Post Print |
| Example ID | Layers | Formulation in Each Layer | of Each Layer | Curl Height (inches) |
| Example C-1-1 | 1 layer | Blend of 80% COC-18 and 20% | 100 | approx. 0.1 |
| | | LLDPE | | |
| Example C-2-1 | 3 layer | (100% LLDPE)/(80% COC-18 + 20% | 20/60/20 | approx. 0.5 |
| Example C-2-2 | | LLDPE)/(100% LLDPE) | 35.5/30/35.5 | approx. 0.5 |
| Example C-2-3 | | | 37.5/25/37.5 | approx. 0.3 |
| Example C-2-4 | | | 42.5/15/42.5 | approx. 0.5 |
| Example C-2-5 | | | 45/10/45 | approx. 0.5 |
| Example C-3-1 | 5 layer | (100% LLDPE)/(70% HPP + 30% | 15/10/50/10/15 | approx. 2.5 |
| Example C-3-2 | | LLDPE)/(100% HPP)/(50% HPP + | 25/10/30/10/25 | approx. 2.5 |
| Example C-3-3 | | 50% LLDPE)/(100% LLDPE) | 32.5/10/15/10/32.5 | approx. 2.5 |
| Example C-4-1 | 5 layer | (100% LLDPE)/(70% HPP + 30% | 30/12.5/15/12.5/ | approx. 0.7 |
| | | LLDPE)/(80% COC-18 + 20% | 30 | |
| Example C-4-2 | | LLDPE)/(70% HPP + 30% LLD | 22.5/20/15/20/22.5 | approx. 0.9 |
| Example C-4-3 | | PE)/(100% LLDPE) | 15/27.5/15/27.5/ | approx. 1.0 |
| | | | 15 | |
| Example C-4-4 | | | 10/32.5/15/32.5/ | approx. 1.5 |
| | | | 10 | |
| Example C-5-1 | 5 layer | (80% HPP + 20% | 10/27.5/25/27.5/ | approx. 0.9 |
| | | LLDPE)/(50% LLDPE + 50% EVA- | 10 | |
| Example C-5-2 | | 18)/(80% COC-18 + 20% | 10/30/20/30/10 | approx. 0.9 |
| Example C-5-3 | | LLDPE)/(50% LLDPE + 50% EVA- | 10/32.5/15/32.5/ | approx. 1.2 |
| | | 18)/(80% HPP + 20% LLDPE) | 10 | |
| Example C-6-1 | 5 layer | (30% HPP + 70% | 15/20/30/20/15 | approx. 0.6 |
| Example C-6-2 | | LLDPE)/(50% EVA + 50% LLDPE)/(80% | 20/20/20/20/20 | 1 |
| Example C-6-3 | | % COC-13 + 20% | 23/20/14/20/23 | 1.5 |
| | | LLDPE)/(50% EVA + 50% LLDPE)/ | | |
| | | (30% HPP + 70% LLDPE) | | |

Table 6 lists the post print curl height of the coextruded film with 50% different grade COC (different Tg temperature) and 50% LLDPE in the core layer. COC-07 and COC-13 each has a Tg about 80° C. or above. Example C-7 series, C-8 series and C-10 series with COC-07 and COC-13 all showed acceptable curl height. COC-03 has a Tg only around 33° C. Example C-9 series exhibited significant post print curl and also tended to jam the printer.

TABLE 6
Curl Height of Various Films

| | | | | Laminate Post |
|---|---|---|---|---|
| | Number | | Layer Thickness | Print Curl |
| Example ID | of Layers | Formulation in Each Layer | % of Each Layer | Height (inches) |
| Example C-7-1 | 1 layer | Blend of 50% COC-13 and 50% LLDPE | 100 | approx. 1.5 |
| Example C-8-1 | 5 layer | (80% HPP + 20% LLDPE)/(50% LLDPE + | 10/20/40/20/10 | approx. 1 |
| Example C-8-2 | | 50% EVA-18)/(50% COC-13 + 50% | 10/25/30/25/10 | approx. 1.2 |
| Example C-8-3 | | LLDPE)/(50% LLDPE + 50% EVA- | 10/30/20/30/20 | approx. 1.4 |
| | | 18)/(80% HPP + 20% LLDPE) | | |
| Example C-9-1 | 5 layer | (80% HPP + 20% LLDPE)/(50% LLDPE + | 15/15/60/15/10 | approx. 2.5 and |
| Example C-9-2 | | 50% EVA-18)/(50% COC-03 + 50% | 10/10/40/10/10 | printing jam |
| | | LLDPE)/(50% LLDPE + 50% EVA- | | approx. 2.5 and |
| | | 18)/(80% HPP + 20% LLDPE) | | printing jam |
| Example C-10-1 | 5 layer | (80% HPP + 20% LLDPE)/(50% LLDPE + | 15/15/60/15/15 | approx. 1.2 |
| Example C-10-2 | | 50% EVA-18)/(50% COC-07 + 50% | 10/10/40/10/10 | approx. 1.5 |
| | | LLDPE)/(50% LLDPE + 50% EVA- | | |
| | | 18)/(80% HPP + 20% LLDPE) | | |

Table 7 lists post print curl height of coextruded film examples with a COC blend in a skin layer and different layer thickness ratios. The results showed that the film has slightly lower post print curl height when the COC blend is in the core or interior layer.

TABLE 7
Curl Height of Various Films

| | | | | Laminate Post |
|---|---|---|---|---|
| | Number | | Layer Thickness | Print Curl |
| Example ID | of Layers | Formulation in Each Layer | % of Each Layer | Height (inches) |
| Example C-11-1 | 3 layer | (80% COC-13 + 20% LLDPE)/(100% | 20/60/20 | approx. 1.5 |
| Example C-11-2 | | LLDPE)/(80% COC-13 + 20% LLDPE) | 30/40/30 | approx. 1.8 |
| Example C-12-1 | 3 layer | (50% COC-13 + 50% LLDPE)/(100% | 20/60/20 | approx. 2.2 |
| Example C-12-2 | | LLDPE)/(50% COC-13 + 50% LLDPE) | 30/40/30 | approx. 1.4 |
| Example C-13-1 | | (100% COC-13)/(100% LLDPE)/(100% | 20/60/20 | approx. 0.1 |
| | | COC-13) | | |
| Example C-14-1 | 3 layer | (80% COC-13 + 20% LLDPE)/(30% | 30/40/30 | approx. 0.8 |
| Example C-14-2 | | LLDPE + 70% EVA-18)/(80% COC-13 + | 20/60/20 | approx. 1 |
| Example C-14-3 | | 20% LLDPE) | 10/80/10 | approx. 2 |

Table 8 lists the post print curl height of coextruded film with GPPS or HIPS in the core layer. GPPS and HIPS have poor compability with polyethylene and polypropylene. In the examples below, SEBS and EVA-18 are used as a tie layer to bond the GPPS or HIPS core with the polyolefin skin layer. Both GPPS and HIPS have a Tg greater than 80° C. Examples D-1, D-2, D-3, D-4 series all showed acceptable post print curl level.

TABLE 8
Curl Height of Various Films

| | Number | | | Laminate Post |
|---|---|---|---|---|
| | of | | Layer Thickness % of Each | Print Curl |
| Example ID | Layers | Formulation in Each Layer | Layer | Height (inches) |
| Example D-1-1 | 7 layers | (80% HPP + 20% LLDPE)/(100% | 10/7.5/7.5/50/7.5/7.5/10 | 0.2 |
| Example D-1-2 | | LLDPE)/(100% SEBS)/(100% | 10/17.5/7.5/30/7.5/17.5/ | 0.5 |
| | | GPPS)/(100% SEBS)/(100% | 10 | |
| | | LLDPE)/(80% HPP + 20% LLDPE) | | |
| Example D-2-1 | 7 layers | (80% HPP + 20% LLDPE)/(50% | 10/10/10/40/10/10/10 | 0.5 |
| Example D-2-2 | | LLDPE + 50% EVA-18)/(100% | 10/15/10/30/10/15/10 | 0.5 |
| Example D-2-3 | | SEBS)/(100% GPPS)/(100% | 10/20/10/20/10/20/10 | 0.8 |
| Example D-2-4 | | SEBS)/(100% | 10/17.5/15/15/15/17.5/10 | 1.2 |
| | | LLDPE)/(80% HPP + 20% LLDPE) | | |
| Example D-3-1 | 7 layers | (80% HPP + 20% LLDPE)/(50% | 10/15/10/30/10/15/10 | 1 |
| Example D-3-2 | | LLDPE + 50% EVA-18)/(60% | 10/20/10/20/10/20/10 | 1.5 |
| Example D-3-3 | | SBC + 40% GPPS)/(100% | 10/22.5/10/15/10/22.5/10 | 1.5 |
| | | GPPS)/(100% SEBS)/(100% | | |
| | | LLDPE)/(80% HPP + 20% LLDPE) | | |
| Example D-4-1 | 7 layers | (80% HPP + 20% LLDPE)/(20% | 10/7.5/7.5/50/7.5/7.5/10 | 0.5 |
| Example D-4-2 | | HPP + 80% LLDPE)/(50% | 10/15/10/30/10/15/10 | 0.5 |
| Example D-4-3 | | GPPS + 50% EVA-18)/(100% | 10/20/10/20/10/20/10 | 0.8 |
| Example D-4-4 | | GPPS)/(50% GPPS + 50% EVA- | 10/25/10/10/10/15/10 | 1 |
| | | 18)/(20% | | |
| | | HPP + 80% LLDPE)/(80% | | |
| | | HPP + 20% LLDPE) | | |
| Example D-5-1 | 5 layers | (30% HPP + 70% LLDPE)/(50% | 30/10/20/10/30 | 1 |
| | | GPPS + 50% EVA-18)/(100% | | |
| | | GPPS)/(50% GPPS + 50% EVA- | | |
| | | 18)/(30% HPP + 70% LLDPE) | | |
| Example D-6-1 | 5 layers | (30% HPP + 70% LLDPE)/(100% | 15/20/30/20/15 | 0.6 |
| Example D-6-2 | | EVA-18)/(100% GPPS)/(100% | 27/11/25/11/27 | 1 |
| Example D-6-3 | | EVA-18)/(30% | 30/15/10/15/20 | 1.2 |
| | | HPP + 70% LLDPE) | | |
| Example D-7-1 | 7 layers | (80% HPP + 20% LLDPE)/(20% | 10/7.5/7.5/50/7.5/7.5/10 | 0.5 |
| Example D-7-2 | | HPP + 80% LLDPE)/(50% | 10/15/10/30/10/15/10 | 0.9 |
| Example D-7-3 | | HIPS + 50% EVA-18)/(100% | 10/20/10/20/10/20/10 | 0.9 |
| Example D-7-4 | | GPPS)/(50% HIPS + 50% EVA- | 10/25/10/10/10/15/10 | 1.2 |
| | | 18)/(20% | | |
| | | HPP + 80% LLDPE)/(80% | | |
| | | HPP + 20% LLDPE) | | |

The post print layflat characteristic of the laminate is also related to the stiffness and shrink of the liner. The liner used in examples in the present subject matter is 85# polycoated paper liner. Increasing the weight of paper liner can further reduce the post print curl. Also laminates with non-polycoated paper liner give slightly lower post print curl due to the shrink of the liner on the non-print side as result of losing moisture during printing. An optimized combination of face film and liner can give a cost effective laser printer print laminate.

Rolls of laminate with face films comprise COC-13, or GPPS were selectively tested for label convertibility and modulus for label application. The results are listed in Table 9. Table 9 indicates these examples are suitable for a label converting process and exhibit sufficiently high modulus for label application.

TABLE 9
Tensile Modulus of Various Films

| | Die | Matrix | | | Tensile E Modulus in | Tensile E Modulus in |
|---|---|---|---|---|---|---|
| Example ID | Cutability | Stripping | Perforation | Sheeting | CD Direction (psi) | MD Direction (psi) |
| Example D-5-1 | Good | Good | Good | Good | 135K | 179K |
| Example D-6-1 | Good | Good | Good | Good | 196K | 192K |
| Example D-6-2 | Good | Good | Good | Good | 130K | 157K |
| Example D-6-3 | Good | Good | Good | Good | 96K | 106K |
| Example C-6-1 | Good | Good | Good | Good | 126K | 142K |
| Example C-6-2 | Good | Good | Good | Good | 111K | 118K |
| Example C-6-3 | Good | Good | Good | Good | 78K | 107K |

Other additives and fillers such as antiblock agents, UV block agents, processing aids, matting agents, pigments, may be added in the film formulation(s) depending on application requirements.

In certain applications, some coatings may be applied to give labels other functionality such as enhancing laser printer ink anchorage, analogue printer ability, surface abrasion resistance, static control, surface gloss level, etc.

Although many embodiments of the present subject matter are directed to providing printing media or label laminates which can be used in laser printing or other applications in which printed sheets tend to curl after printing, it will be understood that the present subject matter is not limited to such and instead can be used in a variety of other applications.

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous films, labels, strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A film comprising a blend of:
at least one polyolefin having a Tg less than 20° C.;
at least one polymer having a Tg of at least 80° C.;
wherein the weight proportion of the at least one polymer having a Tg of at least 80° C. is at least 10% based upon the total weight of the film, the film is free of polyvinyl chloride, and the film exhibits a shrinkage of less than 1% after exposure to 100° C. for 1 hour.

2. The film of claim 1 wherein the at least one polyolefin having a Tg less than 20° C. is selected from the group consisting of polyethylene, polypropylene, polyethylene polypropylene copolymer, polyolefin elastomer, modified polyolefin, and combinations thereof.

3. The film of claim 1 wherein the at least one polymer having a Tg of at least 80° C. is selected from the group consisting of polystyrene, impact modified polystyrene, polystyrene based copolymer, cyclic polyolefin copolymers including norbornene, nylon, polycarbonates, polyesters, acrylics, polyimide, and combinations thereof.

4. The film of claim 1 wherein the film also comprises at least one additive.

5. The film of claim 4 wherein the additive is selected from the group consisting of an antiblock agent, a processing aid, a slip agent, an antistatic agent, a pigment, a cavitating agent, an inorganic filler, an antioxidant, and combinations thereof.

6. A multilayer film comprising:
a first layer including at least one polyolefin having a Tg less than 20° C.;
a second layer including at least one polymer having a Tg of at least 80° C.;
wherein the weight proportion of the at least one polymer having a Tg of at least 80° C. is at least 10% based upon the total weight of the film, and the film is free of polyvinyl chloride.

7. The multilayer film of claim 6 further comprising:
a third layer disposed between the first layer and the second layer.

8. The multilayer film of claim 7 wherein the composition of the third layer is the same as the composition of at least one of the first layer and the second layer.

9. The multilayer film of claim 7 wherein the composition of the third layer is different than the composition of at least one of the first layer and the second layer.

10. The multilayer film of claim 6 further comprising:
a third layer, the first layer disposed between the second layer and the third layer.

11. The multilayer film of claim 10 wherein the composition of the third layer is the same as the composition of at least one of the first layer and the second layer.

12. The multilayer film of claim 10 wherein the composition of the third layer is different than the composition of at least one of the first layer and the second layer.

13. The multilayer film of claim 6 further comprising:
a third layer, the second layer disposed between the first layer and the third layer.

14. The multilayer film of claim 13 wherein the composition of the third layer is the same as the composition of at least one of the first layer and the second layer.

15. The multilayer film of claim 13 wherein the composition of the third layer is different than the composition of at least one of the first layer and the second layer.

16. The film of claim 6 wherein the at least one polyolefin having a Tg less than 20° C. is selected from the group consisting of polyethylene, polypropylene, polyethylene polypropylene copolymer, polyolefin elastomer, modified polyolefin, and combinations thereof.

17. The film of claim 6 wherein the at least one polymer having a Tg of at least 80° C. is selected from the group consisting of polystyrene, impact modified polystyrene, polystyrene based copolymer, cyclic polyolefin copolymers including norbornene, nylon, polycarbonates, polyesters, acrylics, polyimide, and combinations thereof.

18. The film of claim 6 wherein the film also comprises at least one additive.

19. The film of claim 18 wherein the additive is selected from the group consisting of an antiblock agent, a processing aid, a slip agent, an antistatic agent, a pigment, a cavitating agent, an inorganic filler, an antioxidant, and combinations thereof.

20. The film of claim 6 wherein the film exhibits a shrinkage of less than 1% after exposure to 100° C. for 1 hour.

21. A coated film comprising:
a film including a blend of (i) at least one polyolefin having a Tg less than 20° C., (ii) at least one polymer having a Tg of at least 80° C., wherein the weight proportion of the at least one polymer having a Tg of at least 80° C. is at least 10% based upon the total weight of the film, and the film is free of polyvinyl chloride;
the film defining an outer surface;
a coating disposed on the outer surface of the film.

22. The coated film of claim 21 wherein the coating is an ink receptive coating.

23. The coated film of claim 21 wherein the coating is a heat insulating coating comprising particles selected from the group consisting of porous silica particles, porous non-silica particles, and combinations thereof.

24. The coated film of claim 21 wherein the coating is a microporous foam coating.

25. A coated film comprising:
a multilayer film including (i) a first layer including at least one polyolefin having a Tg less than 20° C., (ii) a second layer including at least one polymer having a Tg of at least 80° C., wherein the weight proportion of the at least one polymer having a Tg of at least 80° C. is at least 10% based upon the total weight of the film, and the film is free of polyvinyl chloride;
the multilayer film defining an outer surface;
a coating disposed on the outer surface of the multilayer film.

26. The coated film of claim 25 wherein the coating is an ink receptive coating.

27. The coated film of claim 25 wherein the coating is a heat insulating coating comprising particles selected from the group consisting of porous silica particles, porous non-silica particles, and combinations thereof.

28. The coated film of claim 25 wherein the coating is a microporous foam coating.

29. A label laminate comprising:
a film including a blend of (i) at least one polyolefin having a Tg less than 20° C., (ii) at least one polymer having a Tg of at least 80° C., wherein the weight proportion of the at least one polymer having a Tg of at least 80° C. is at least 10% based upon the total weight of the film, and the film is free of polyvinyl chloride;
pressure sensitive adhesive disposed on the film;
a release liner disposed on the pressure sensitive adhesive.

30. The label laminate of claim 29 wherein the at least one polyolefin having a Tg less than 20° C. is selected from the group consisting of polyethylene, polypropylene, polyethylene polypropylene copolymer, polyolefin elastomer, modified polyolefin, and combinations thereof.

31. The label laminate of claim 29 wherein the at least one polymer having a Tg of at least 80° C. is selected from the group consisting of polystyrene, impact modified polystyrene, polystyrene based copolymer, cyclic polyolefin copolymers including norbornene, nylon, polycarbonates, polyesters, acrylics, polyimide, and combinations thereof.

32. The label laminate of claim 29 wherein the film also comprises at least one additive.

33. The label laminate of claim 32 wherein the additive is selected from the group consisting of an antiblock agent, a processing aid, a slip agent, an antistatic agent, a pigment, a cavitating agent, an inorganic filler, an antioxidant, and combinations thereof.

34. The label laminate of claim 29 wherein the film exhibits a shrinkage of less than 1% after exposure to 100° C. for 1 hour.

35. The label laminate of claim 29 wherein the label laminate exhibits an average curl height after printing of less than 2.0 inches.

36. The label laminate of claim 35 wherein the average curl height is less than 1.5 inches.

37. The label laminate of claim 36 wherein the average curl height is less than 1.0 inch.

38. The label laminate of claim 37 wherein the average curl height is less than 0.5 inches.

39. A label laminate comprising:
a multilayer film including (i) a first layer including at least one polyolefin having a Tg less than 20° C., (ii) a second layer including at least one polymer having a Tg of at least 80° C., wherein the weight proportion of the at least one polymer having a Tg of at least 80° C. is at least 10% based upon the total weight of the film, and the film is free of polyvinyl chloride;
pressure sensitive adhesive disposed on the multilayer film;
a release liner disposed on the pressure sensitive adhesive.

40. The label laminate of claim 39 wherein the at least one polyolefin having a Tg less than 20° C. is selected from the group consisting of polyethylene, polypropylene, polyethylene polypropylene copolymer, polyolefin elastomer, modified polyolefin, and combinations thereof.

41. The label laminate of claim 39 wherein the at least one polymer having a Tg of at least 80° C. is selected from the group consisting of polystyrene, impact modified polystyrene, polystyrene based copolymer, cyclic polyolefin copolymers including norbornene, nylon, polycarbonates, polyesters, acrylics, polyimide, and combinations thereof.

42. The label laminate of claim 39 wherein the film also comprises at least one additive.

43. The label laminate of claim 42 wherein the additive is selected from the group consisting of an antiblock agent, a processing aid, a slip agent, an antistatic agent, a pigment, a cavitating agent, an inorganic filler, an antioxidant, and combinations thereof.

44. The label laminate of claim 39 wherein the film exhibits a shrinkage of less than 1% after exposure to 100° C. for 1 hour.

45. The label laminate of claim 39 wherein the label laminate exhibits an average curl height after printing of less than 2.0 inches.

46. The label laminate of claim 45 wherein the average curl height is less than 1.5 inches.

47. The label laminate of claim 46 wherein the average curl height is less than 1.0 inch.

48. The label laminate of claim 47 wherein the average curl height is less than 0.5 inches.

49. A single layer film adapted for use as laser print media, the film comprising a blend of:
at least one polyolefin having a Tg less than 20° C.;
at least one polymer having a Tg of at least 80° C.;
wherein the weight proportion of the at least one polymer having a Tg of at least 80° C. is at least 10% based upon the total weight of the film, the film is free of polyvinyl chloride.

50. The film of claim 49 wherein the at least one polyolefin having a Tg less than 20° C. is selected from the group consisting of polyethylene, polypropylene, polyethylene polypropylene copolymer, polyolefin elastomer, modified polyolefin, and combinations thereof.

51. The film of claim 49 wherein the at least one polymer having a Tg of at least 80° C. is selected from the group consisting of polystyrene, impact modified polystyrene, polystyrene based copolymer, cyclic polyolefin copolymers including norbornene, nylon, polycarbonates, polyesters, acrylics, polyimide, and combinations thereof.

52. The film of claim 49 wherein the film also comprises at least one additive.

53. The film of claim 52 wherein the additive is selected from the group consisting of an antiblock agent, a processing aid, a slip agent, an antistatic agent, a pigment, a cavitating agent, an inorganic filler, an antioxidant, and combinations thereof.

54. The film of claim 49 wherein upon incorporation of the film in a sheet of laser print media, and after laser printing, the sheet exhibits an average curl height of less than 2.0 inches.

55. The film of claim 54 wherein the average curl height is less than 1.5 inches.

56. The film of claim 55 wherein the average curl height is less than 1.0 inch.

57. The film of claim 56 wherein the average curl height is less than 0.5 inches.

58. The film of claim 49 wherein the film exhibits a shrinkage of less than 1% after exposure to 100° C. for 1 hour.

59. A method for forming a single layer film comprising:
forming a melt blend of (i) at least one polyolefin having a Tg less than 20° C., and (ii) at least one polymer having a Tg of at least 80° C., wherein the weight proportion of the at least one polymer having a Tg of at least 80° C. is at least 10% based upon the total weight of the film, and the melt blend is free of polyvinyl chloride;
extruding the melt blend into a layer to thereby form the single layer film, whereby the film exhibits a shrinkage of less than 1% after exposure to 100° C. for 1 hour.

60. A single layer film produced by the method of claim 59.

61. A method for forming a multilayer film comprising:
forming a first melt blend including at least one polyolefin having a Tg less than 20° C.;
forming a second melt blend including at least one polymer having a Tg of at least 80° C.;
coextruding the first melt blend and the second melt blend to thereby form the multilayer film, wherein the weight proportion of the at least one polymer having a Tg of at least 80° C. is at least 10% based upon the total weight of the film, and the film is free of polyvinyl chloride.

62. A multilayer film produced by the method of claim 61.
